(19) United States
(12) Patent Application Publication
(10) Pub. No.: US 2005/0122042 A1
(43) Pub. Date: Jun. 9, 2005

(54) Organic electroluminescent display device

(76) Inventors: Tae-Wook Kang, Suwon-si (KR); Chang-Yong Jeong, Suwon-si (KR)

Correspondence Address: Robert E. Bushnell, Suite 300, 1522 K Street, N.W., Washington, DC, 20005, US

(21) Appl. No.: 10/979,109

(22) Filed: Nov. 2, 2004

(30) Foreign Application Priority Data
Nov. 25, 2003 (KR) 2003-84236

(51) Int. Cl. H05B 33/00

(52) U.S. Cl. 313/506; 313/512

(57) ABSTRACT

An organic electroluminescent display device has an organic light-emitting element formed on a lower insulating substrate, an upper insulating substrate for sealing the organic light-emitting element, and a static electricity preventing member formed on the outer surface of the lower insulating substrate on which the organic light-emitting element is formed.

### CLAIM OF PRIORITY

This application claims the benefit of Korean Patent Application No. 2003-84236, filed on Nov. 25, 2003, the disclosure of which is hereby incorporated herein by reference in its entirety.

### BACKGROUND OF THE INVENTION

1. Field of the Invention

The present invention relates to an organic electroluminescent display device, more particularly, to an organic electroluminescent display device comprising a static electricity preventing member.

2. Description of Related Art

Generally, an organic electroluminescent display device is a self emission display that emits light when exciton formed by recombination of electrons and holes is dropped from the excited state to the ground state.

Owing to this principle, an organic electroluminescent display device according to the present invention has merits in that volume and weight of the device are reduced since, unlike a conventional thin film liquid crystal display device, it does not require a separate source of light.

A method for driving the organic electroluminescent display device is divided into a passive matrix type organic electroluminescent display device and an active matrix type organic electroluminescent display device.

The passive matrix type organic electroluminescent display device has demerits in that power consumption is high, it has difficulty forming a display device having large area, and the more the number of wirings is increased, the more its opening ratio is dropped although its fabrication method is simple due to its simple structure.

Therefore, the passive matrix type organic electroluminescent display device is used in case that the organic electroluminescent display device is applied to a small sized display device while the active matrix type organic electroluminescent display device is used in case that the organic electroluminescent display device is applied to a display device having large area.

The conventional organic electroluminescent display devices are formed in such a shape that an organic-light emitting element of the organic electroluminescent display device is formed on one surface of an insulating substrate, and of which the other surface is exposed to the outside. Since static electricity is generated by external environmental factors such as friction, the exposure of the other surface to the external environmental factors causes disconnection of wiring of the organic electroluminescent display device, defects of image quality and breakdown of the organic light-emitting element. Furthermore, a thin film transistor of the active matrix type organic electroluminescent display device for driving the organic light-emitting element is destroyed, and misoperation of the thin film transistor causes defects of image quality.

In order to solve the foregoing problems, Korean Patent Publication No. 2003-11986 discloses a structure for preventing static electricity by forming a transparent conductive material layer such as Indium Tin Oxide (ITO) on a substrate arranged in an emitting direction of an organic electroluminescent display device.

However, there is a problem that it is difficult to apply using of the ITO as a static electricity preventing structure to an active matrix type organic electroluminescent display device in which a plurality of heat treating processes are used since the ITO is changed in the heat treatment processes to cause defects of ITO film, and vacuum plasma equipment such as plasma enhanced chemical vapor deposition (PECVD) is contaminated.

### SUMMARY OF THE INVENTION

It is, therefore, an object of the present invention to provide an improved organic electroluminescent display device

It is a further object of the present invention to provide an organic electroluminescent display device having an improved static electricity preventing member.

It is also an object of the present invention to provide an organic electroluminescent display device capable of preventing disconnection of wiring, defects of picture quality, and breakdown.

It is another object of the present invention to provide a method for fabricating the organic electroluminescent display device having a static electricity preventing member.

In order to achieve the foregoing and other objects, the present invention may be constructed with an organic electroluminescent display device comprising an organic light-emitting element formed on a first insulating substrate; a second insulating substrate for sealing the organic light-emitting element, and a static electricity preventing member formed on the outer surface of the first insulating substrate on which the organic light-emitting element is formed.

The static electricity preventing member is preferably a static electricity preventing coating, and it is preferable that the static electricity preventing coating has a surface resistance of 10¹² Ohm/cm² or less. It is more preferable that the static electricity preventing coating is formed of a material containing at least one of the static electricity preventing coating agent selected from the group consisting of conductive carbon, metal powder and a conductive polymer. It is preferable that the metal powder is antimony zinc oxide (AZO), and the conductive polymer is polythiophene, polyaniline or polypyrrol.

It is preferable that the static electricity preventing member is an antistatic film, and the antistatic film has surface resistance of 10¹² ohm/cm² or less. It is more preferable that the antistatic film is a film comprising at least one of the material selected from the group consisting of conductive carbon, metal powder, a conductive polymer, a conductive oligomer and a conductive monomer, and the antistatic film is a metal layer-embedded film.

The static electricity preventing member is preferably a static electricity preventing metal film grounded to the outside through wiring.

Furthermore, the present invention provides a method for fabricating an organic electroluminescent display device comprising the steps of forming an organic light-emitting element on a first insulating substrate; sealing the organic light-emitting element with a second insulating substrate; and depositing a static electricity preventing member on the outer surface of the first insulating substrate.

It is preferable that the static electricity preventing metal film is deposited on the outer surface of the first insulating substrate using plasma.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1A and FIG. 1B are cross sectional views for describing an organic electroluminescent display device according to preferred embodiments of the present invention.

### DETAILED DESCRIPTION OF THE PREFERRED EMBODIMENTS

The present invention will now be described in detail in connection with preferred embodiments with reference to the accompanying drawings. For reference, like reference characters designate corresponding parts throughout several views.

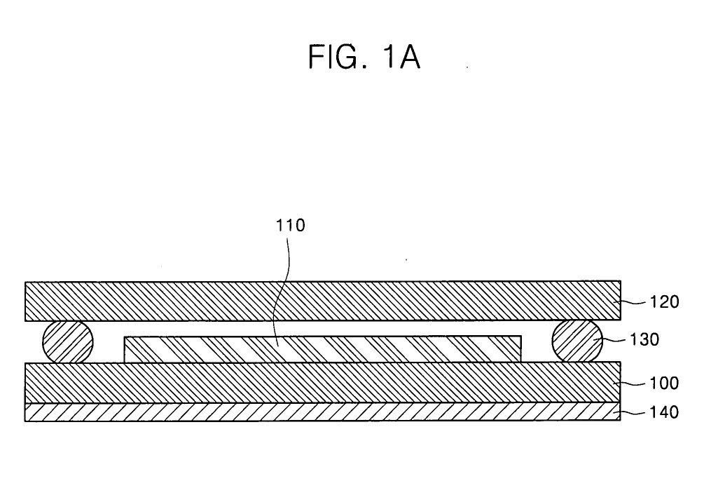

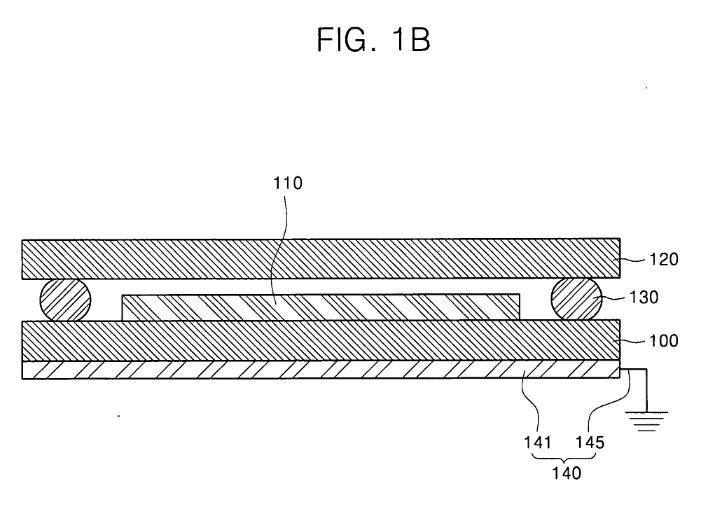

FIG. 1A and FIG. 1B are drawings for describing cross sectional structure of an organic electroluminescent display device according to preferred embodiments of the present invention. An organic electroluminescent display device according to preferred embodiments of the present invention is constructed in such a structure that a static electricity preventing member is formed on the outer surface of an insulating substrate on which an organic light-emitting element is formed.

Referring to FIG. 1A and FIG. 1B, an organic light-emitting element 110 is formed on a lower insulating substrate 100 on which a thin film transistor is formed.

The organic light-emitting element 110 comprises a first electrode, an organic light-emitting layer and a second electrode, wherein one of the first electrode and the second electrode acts as a cathode and the other acts as an anode. That is, the second electrode acts as a cathode electrode if the first electrode acts as an anode electrode, and the second electrode acts as the anode electrode if the first electrode acts as the cathode electrode.

Furthermore, the organic light-emitting layer is comprised of various layers according to function of the organic light-emitting layer and generally formed in a multilayered structure comprising at least one of the layers selected from the group consisting of a light-emitting layer, a hole injection layer (HIL), a hole transport layer (HTL), a hole blocking layer (HBL), an electron transport layer (ETL) and an electron injection layer (EIL).

The organic light-emitting element 110 is preferably sealed with a cover (e.g., an upper insulating substrate 120) using sealant 130 after forming the organic light-emitting element 110.

Then, a static electricity preventing member 140 is formed on the outer surface of the lower insulating substrate 100.

The static electricity preventing member 140 is preferably a static electricity preventing metal film 141 grounded to the outside through wiring 145.

The static electricity preventing member 140 is preferably the static electricity preventing coating formed on the outer surface of the lower insulating substrate 100 as illustrated in FIG. 1A and formed of a material containing a static electricity preventing coating agent such as conductive carbon, metal powder or a conductive polymer.

It is preferable that the metal powder in the static electricity preventing coating agent used on the static electricity preventing coating is antimony zinc oxide (AZO), and the conductive polymer is a conductive polymer such as polythiophene, polyaniline or polypyrrol.

Furthermore, the static electricity preventing member 140 is preferably the antistatic film formed on the outer surface of the lower insulating substrate 100 as illustrated in FIG. 1A. the antistatic film is a film containing conductive carbon, metal powder, a conductive polymer, a conductive oligomer or a conductive monomer, or a metal layer-embedded film.

A synthetic resin film (plastic film) is used as a substrate for the antistatic film, and the synthetic resin film is commonly used as an antistatic film such as polyethylene (PE), polyethylene terephthalate (PET), polyvinyl chloride (PVC), polyvinyl alcohol (PVA), polymethylmethacrylate (PMMA), polycarbonate (PC), polypropylene (PP), polystyrene (PS) and acrylonitrile-butadiene-styrene copolymer (ABS).

It is preferable that the static electricity preventing coating or the antistatic film as the static electricity preventing member 140 has surface resistance of 10¹² ohm/cm² or less to suppress generation of static electricity on the surface of the static electricity preventing coating or the antistatic film.

Furthermore, the static electricity preventing metal film 141 as the static electricity preventing member 140 is formed by depositing a certain conductive metal on the outer surface of the lower insulating substrate 100 as illustrated in FIG. 1B, wherein it is preferable that the static electricity preventing metal film 141 is deposited using plasma, and the static electricity preventing metal film 141 is grounded to the outside through wiring 145.

Furthermore, the static electricity preventing member 140 can be formed on the polarizer or polarizing film if a polarizer or polarizing film (not illustrated on FIG. 1B) is formed on the outer surface of the lower insulating substrate 100.

As described in the above, the static electricity preventing member 140 is formed on the outer surface of the lower insulating substrate 100 since a thin film transistor for driving various wirings and organic electroluminescent display device on which static electricity generated by external factors including friction directly exerts influence is formed on the lower insulating substrate 100. Furthermore, it is more effective that the static electricity preventing member 140 is formed on the outer surface of the lower insulating substrate 100 than that the static electricity preventing member 140 is formed on the upper insulating substrate 120 since the upper insulating substrate 120 is positioned with being spaced apart from the lower insulating substrate 100 comprising the organic light-emitting element 110 in a certain distance.

The foregoing organic electroluminescent display device is capable of preventing static electricity generated, thereby preventing wiring disconnection, deterioration of picture quality and breakage of a light-emitting element of the organic electroluminescent display device due to static electricity by external factors during the fabrication process of the organic electroluminescent display device or after completion of a product.

Furthermore, the organic electroluminescent display device is capable of preventing defects of picture quality due to breakage and misoperation of a thin film transistor.

According to the present invention as described in the above, the present invention is capable of providing an organic electroluminescent display device for preventing wire disconnection of the organic electroluminescent display device, defects of picture quality and breakage of an organic light-emitting element by forming a static electricity preventing member on the outer surface of an insulating substrate on which the organic light-emitting element of the organic electroluminescent display device is formed, thereby preventing static electricity generated by external environmental factors including friction.

While the invention has been particularly shown and described with reference to preferred embodiments thereof, it will be understood by those skilled in the art that the foregoing and other changes in form and details may be made therein without departing from the spirit and scope of the invention.

1. An organic electroluminescent display device, comprising:
a first insulating substrate;
an organic light-emitting element formed on said first insulating substrate;
a second insulating substrate for sealing the organic light-emitting element; and
a static electricity preventing member formed on an outer surface of the first insulating substrate.

2. The organic electroluminescent display device according to claim 1, wherein the static electricity preventing member is a static electricity preventing coating.

3. The organic electroluminescent display device according to claim 2, wherein the static electricity preventing coating has a surface resistance of 10¹² Ohm/cm² or less.

4. The organic electroluminescent display device according to claim 2, wherein the static electricity preventing coating is formed of a material containing at least one of the static electricity preventing coating agent selected from the group consisting of conductive carbon, metal powder and a conductive polymer.

5. The organic electroluminescent display device according to claim 4, wherein the metal powder is antimony zinc oxide (AZO).

6. The organic electroluminescent display device according to claim 4, wherein the conductive polymer is polythiophene, polyaniline or polypyrrol.

7. The organic electroluminescent display device according to claim 1, wherein the static electricity preventing member is an antistatic film.

8. The organic electroluminescent display device according to claim 7, wherein the antistatic film has surface resistance of 10¹² ohm/cm² or less.

9. The organic electroluminescent display device according to claim 7, wherein the antistatic film comprises at least one of the material selected from the group consisting of conductive carbon, metal powder, a conductive polymer, a conductive oligomer and a conductive monomer.

10. The organic electroluminescent display device according to claim 7, wherein the antistatic film comprises a synthetic resin film selected from the group consisting of polyethylene (PE), polyethylene terephthalate (PET), polyvinyl chloride (PVC), polyvinyl alcohol (PVA), polymethylmethacrylate (PMMA), polycarbonate (PC), polypropylene (PP), polystyrene (PS) and acrylonitrile-butadiene-styrene copolymer (ABS).

11. The organic electroluminescent display device according to claim 7, wherein the antistatic film is a metal layer-embedded film.

12. The organic electroluminescent display device according to claim 1, wherein the static electricity preventing member is a static electricity preventing metal film grounded to the outside through wiring.

13. The organic electroluminescent display device according to claim 1, wherein the first insulating substrate further has a polarizing film on the outer surface of the first insulating substrate, and the static electricity preventing member is formed on the outer surface of the polarizing film.

14. A method for fabricating an organic electroluminescent display device, comprising the steps of:
forming an organic light-emitting device on a first insulating substrate;
sealing the organic light-emitting device with a second insulating substrate; and
depositing a static electricity preventing member on the outer surface of the first insulating substrate.

15. The method for fabricating an organic electroluminescent display device according to claim 14, wherein the static electricity preventing member is deposited on the outer surface of the first insulating substrate using plasma.

16. The method for fabricating an organic electroluminescent display device according to claim 14, wherein the static electricity preventing member is a static electricity preventing coating formed of a material containing at least one selected from the group consisting of conductive carbon, metal powder and a conductive polymer.

17. The method for fabricating an organic electroluminescent display device according to claim 14, wherein the static electricity preventing member is an antistatic film comprises at least one selected from the group consisting of conductive carbon, metal powder, a conductive polymer, a conductive oligomer, a conductive monomer, and a metal-layer embedded film.

18. An organic electroluminescent display device fabricated by the method of claim 14.

19. An organic electroluminescent display device comprising:
a substrate;
an organic light-emitting element formed on one surface of said substrate;
a cover for sealing the organic light-emitting element formed on said substrate; and
a static electricity preventing member formed on the other surface of the substrate to prevent a static electricity, said static electricity preventing member comprising at least one selected from the group consisting of conductive carbon, antimony zinc oxide (AZO), conductive polymer, conductive oligomer, a conductive monomer, and a synthetic resin film.

20. The organic electroluminescent display device according to claim 19, wherein the static electricity preventing coating has a surface resistance of 10¹² Ohm/cm² or less.
